(19) United States
(12) Patent Application Publication
(10) Pub. No.: US 2025/0046495 A1
(43) Pub. Date: Feb. 6, 2025

(54) SUPERCONDUCTING WIRE CONNECTION STRUCTURE

(71) Applicant: SUMITOMO ELECTRIC INDUSTRIES, LTD., Osaka (JP)

(72) Inventor: Kotaro OHKI, Osaka (JP)

(73) Assignee: SUMITOMO ELECTRIC INDUSTRIES, LTD., Osaka (JP)

(21) Appl. No.: 18/718,307

(22) PCT Filed: Aug. 19, 2022
(86) PCT No.: PCT/JP2022/031395

§ 371 Date: Jun. 10, 2024

(30) Foreign Application Priority Data
Dec. 15, 2021 (JP) 2021-203579

(51) Int. Cl. H01B 12/06; H01R 4/68

(52) U.S. Cl. CPC H01B 12/06; H01R 4/68

(57) ABSTRACT

A superconducting wire connection structure includes a first superconducting wire and a second superconducting wire. The first superconducting wire has a first end portion in a longitudinal direction of the first superconducting wire. The second superconducting wire has a second end portion in a longitudinal direction of the second superconducting wire. Each of the first superconducting wire and the second superconducting wire has a base material, an intermediate layer disposed on the base material, and a superconducting layer disposed on the intermediate layer. A connection portion, which is a portion of the superconducting wire connection structure where the superconducting layer at the first end portion and the superconducting layer at the second end portion are connected, has a first sandwiching member and a second sandwiching member.

### TECHNICAL FIELD

The present disclosure relates to a superconducting wire connection structure. The present application claims priority based on Japanese Patent Application No. 2021-203579 filed on Dec. 15, 2021. The entire contents described in the Japanese patent application are incorporated herein by reference.

### BACKGROUND ART

International Publication No. 2016/129469 (PTL 1) describes a superconducting wire connection structure. The superconducting wire connection structure described in PTL 1 has a first superconducting wire, a second superconducting wire, and a joining layer. Each of the first superconducting wire and the second superconducting wire has a metal substrate, an intermediate layer, and a superconducting layer. The intermediate layer is disposed on the metal substrate. The superconducting layer is disposed on the intermediate layer. The first superconducting wire has a first end portion in a longitudinal direction of the first superconducting wire. The second superconducting wire has a second end portion in a longitudinal direction of the second superconducting wire.

In the superconducting wire connection structure described in PTL 1, the superconducting layer at the first end portion and the superconducting layer at the second end portion are superconducting-joined with the joining layer being interposed therebetween.

### CITATION LIST

### Patent Literature

PTL 1: International Publication No. 2016/129469

### SUMMARY OF INVENTION

A superconducting wire connection structure of the present disclosure includes a first superconducting wire and a second superconducting wire. The first superconducting wire has a first end portion in a longitudinal direction of the first superconducting wire. The second superconducting wire has a second end portion in a longitudinal direction of the second superconducting wire. Each of the first superconducting wire and the second superconducting wire has a base material, an intermediate layer disposed on the base material, and a superconducting layer disposed on the intermediate layer. A connection portion, which is a portion of the superconducting wire connection structure where the superconducting layer at the first end portion and the superconducting layer at the second end portion are connected, has a first sandwiching member and a second sandwiching member. The superconducting layer at the first end portion and the superconducting layer at the second end portion are sandwiched between the first sandwiching member and the second sandwiching member. A thickness of the connection portion is less than or equal to 2 mm. A thermal expansion coefficient of the first sandwiching member and a thermal expansion coefficient of the second sandwiching member are more than or equal to 0.95 times and less than or equal to 1.05 times a thermal expansion coefficient of the base material.

### BRIEF DESCRIPTION OF DRAWINGS

FIG. 1 is a plan view of a superconducting wire connection structure 100.

FIG. 2 is a cross sectional view taken along II-II in FIG. 1.

FIG. 3 is a cross sectional view taken along III-III in FIG. 1.

FIG. 4 is a manufacturing process diagram of superconducting wire connection structure 100.

FIG. 5 is a cross sectional view of superconducting wire connection structure 100 in accordance with a second variation.

FIG. 6 is a plan view of superconducting wire connection structure 100 in accordance with a third variation.

FIG. 7 is a cross sectional view taken along VII-VII in FIG. 6.

FIG. 8 is a cross sectional view of superconducting wire connection structure 100 in accordance with a fourth variation.

FIG. 9 is a cross sectional view of superconducting wire connection structure 100 in accordance with a fifth variation.

FIG. 10 is a cross sectional view of superconducting wire connection structure 100 in accordance with a sixth variation.

### DETAILED DESCRIPTION

### Problem to be Solved by the Present Disclosure

In order to prevent breakage in a connection portion (a portion where the superconducting layer at the first end portion and the superconducting layer at the second end portion are connected by the joining layer) of the superconducting wire connection structure described in PTL 1, it is conceivable to sandwich the first end portion and the second end portion between a pair of plate members (hereinafter referred to as a “first plate member” and a “second plate member”), and fix the first plate member and the second plate member by screws.

In this case, however, it is necessary to form screw holes in the first plate member and the second plate member. Thus, the first plate member and the second plate member have large thicknesses, and heat dissipation in the connection portion becomes low. If the heat dissipation in the connection portion is low, a quench may occur in the superconducting layers at the connection portion when the temperature in the connection portion rises.

The present disclosure has been made in view of the aforementioned problem. More specifically, the present disclosure provides a superconducting wire connection structure that can improve heat dissipation in a connection portion while preventing breakage in the connection portion.

### Advantageous Effect of the Present Disclosure

According to the superconducting wire connection structure of the present disclosure, it is possible to improve heat dissipation in a connection portion while preventing breakage in the connection portion.

### Description of Embodiment of the Present Disclosure

First, an embodiment of the present disclosure will be described in list form.

(1) A superconducting wire connection structure in accordance with the embodiment includes a first superconducting wire and a second superconducting wire. The first superconducting wire has a first end portion in a longitudinal direction of the first superconducting wire. The second superconducting wire has a second end portion in a longitudinal direction of the second superconducting wire. Each of the first superconducting wire and the second superconducting wire has a base material, an intermediate layer disposed on the base material, and a superconducting layer disposed on the intermediate layer. A connection portion, which is a portion of the superconducting wire connection structure where the superconducting layer at the first end portion and the superconducting layer at the second end portion are connected, has a first sandwiching member and a second sandwiching member. The superconducting layer at the first end portion and the superconducting layer at the second end portion are sandwiched between the first sandwiching member and the second sandwiching member. A thickness of the connection portion is less than or equal to 2 mm. A thermal expansion coefficient of the first sandwiching member and a thermal expansion coefficient of the second sandwiching member are more than or equal to 0.95 times and less than or equal to 1.05 times a thermal expansion coefficient of the base material.

According to the superconducting wire connection structure described above in (1), it is possible to improve heat dissipation in a connection portion while preventing breakage in the connection portion.

(2) In the superconducting wire connection structure described above in (1), the connection portion may further have a cover member. The first sandwiching member and the second sandwiching member may be covered with the cover member. A thermal expansion coefficient of the cover member may be more than or equal to 0.95 times and less than or equal to 1.05 times the thermal expansion coefficient of the base material.

According to the superconducting wire connection structure described above in (2), waterproofness in the connection portion can be improved.

(3) The superconducting wire connection structure described above in (2) may further include a third superconducting wire. The third superconducting wire may have the base material, the intermediate layer, and the superconducting layer. The superconducting layer of the third superconducting wire may be disposed to face the superconducting layer at the first end portion and the superconducting layer at the second end portion. The first sandwiching member and the second sandwiching member may sandwich therebetween the first end portion, the second end portion, and the third superconducting wire.

(4) In the superconducting wire connection structure described above in (2) or (3), a thermal conductivity of the first sandwiching member, a thermal conductivity of the second sandwiching member, and a thermal conductivity of the cover member may be more than or equal to 0.1×10² W/m·° C. A thickness of the first sandwiching member and a thickness of the second sandwiching member may be less than or equal to 0.2 mm.

According to the superconducting wire connection structure described above in (4), the heat dissipation in the connection portion can be further improved.

(5) In the superconducting wire connection structure described above in (2) to (4), a thermal resistance of the connection portion may be more than or equal to 16° C./W.

According to the superconducting wire connection structure described above in (5), the amount of heat generated in the connection portion can be decreased.

(6) In the superconducting wire connection structure described above in (1) to (5), a c-axis direction of crystal grains of an oxide superconductor constituting the superconducting layer may be along a thickness direction of the superconducting layer. A current density in the c-axis direction of the superconducting layers at the connection portion when a current of 200 A is flowing through the superconducting wire connection structure may be less than or equal to 50 A/mm².

According to the superconducting wire connection structure described above in (6), the heat dissipation in the connection portion can be further improved.

### Details of Embodiment of the Present Disclosure

Next, details of the embodiment of the present disclosure will be described with reference to the drawings. In the drawings below, identical or corresponding parts will be designated by the same reference numerals, and overlapping description will not be repeated.

(Configuration of Superconducting Wire Connection Structure in Accordance with Embodiment)

In the following, the superconducting wire connection structure in accordance with the embodiment will be described. The superconducting wire connection structure in accordance with the embodiment is referred to as a superconducting wire connection structure 100.

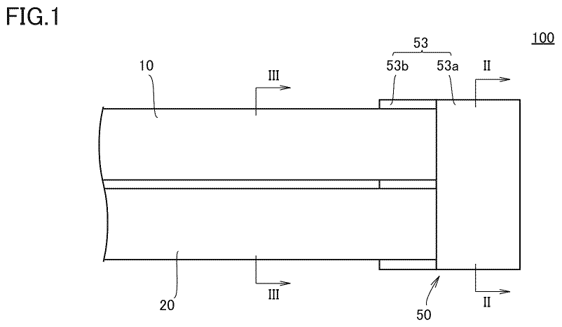

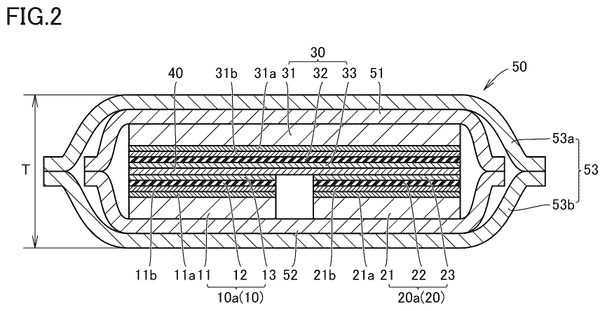

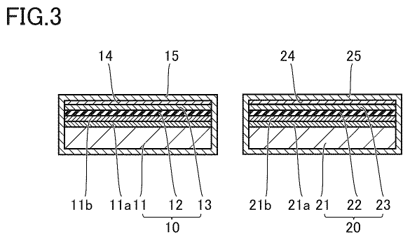

FIG. 1 is a plan view of superconducting wire connection structure 100. FIG. 2 is a cross sectional view taken along II-II in FIG. 1. FIG. 3 is a cross sectional view taken along III-III in FIG. 1. As shown in FIGS. 1 to 3, superconducting wire connection structure 100 has a first superconducting wire 10 and a second superconducting wire 20.

First superconducting wire 10 has a base material 11, an intermediate layer 12, a superconducting layer 13, a protective layer 14, and a stabilization layer 15.

Base material 11 is a tape made of stainless steel, for example. On base material 11, a copper layer 11a and a nickel layer 11b are cladded. Copper layer 11a is disposed on base material 11, and nickel layer 11b is disposed on copper layer 11a. Copper layer 11a and nickel layer 11b are crystal-oriented. However, base material 11 is not limited thereto. Base material 11 may be made of Hastelloy (registered trademark). When base material 11 is made of Hastelloy, copper layer 11a and nickel layer 11b are not cladded.

Intermediate layer 12 is disposed on base material 11. When base material 11 is a tape made of stainless steel, copper layer 11a and nickel layer 11b are interposed between intermediate layer 12 and base material 11. Intermediate layer 12 is constituted by sequentially stacking a layer of stabilized zirconia (YSZ), a layer of yttrium oxide (Y₂O₃), and a layer of cerium oxide (CeO₂), for example. Since nickel layer 11b is crystal-oriented as described above, intermediate layer 12 disposed thereon is also crystal-oriented. Intermediate layer 12 is formed by magnetron sputtering, for example. It should be noted that, when base material 11 is Hastelloy or the like, crystal-oriented intermediate layer 12 is formed by IBAD (Ion Beam Assisted Deposition), for example.

Superconducting layer 13 is disposed on intermediate layer 12. Superconducting layer 13 is made of a REBCO. The REBCO is represented by REBaCu₃O_{y}, where RE is a rare earth element. The rare earth element is yttrium (Y), praseodymium (Pr), neodymium (Nd), samarium (Sm), europium (Eu), gadolinium (Gd), holmium (Ho), ytterbium (Yb), or the like, for example. Superconducting layer 13 is formed by PLD (Pulsed Laser Deposition), for example. Superconducting layer 13 may be formed by MOD (Metal Organic Deposition).

Since intermediate layer 12 is crystal-oriented as described above, superconducting layer 13 disposed thereon is also crystal-oriented. More specifically, a c-axis of crystal grains of the REBCO constituting superconducting layer 13 is along a thickness direction of superconducting layer 13.

Protective layer 14 is disposed on superconducting layer 13. Protective layer 14 is made of silver (Ag). Protective layer 14 may be made of a silver alloy. Protective layer 14 is formed by sputtering, for example.

Stabilization layer 15 is disposed on protective layer 14. Stabilization layer 15 is also disposed on a surface of base material 11 opposite to intermediate layer 12, on side surfaces of base material 11, on side surfaces of intermediate layer 12, on side surfaces of superconducting layer 13, and on side surfaces of protective layer 14. Stabilization layer 15 is made of copper. Stabilization layer 15 may be made of a copper alloy. Stabilization layer 15 is formed by plating, for example.

First superconducting wire 10 has a first end portion 10a. First end portion 10a is an end portion in a longitudinal direction of first superconducting wire 10. At first end portion 10a, protective layer 14 and stabilization layer 15 are removed. That is, at first end portion 10a, superconducting layer 13 is exposed.

Second superconducting wire 20 has a base material 21, an intermediate layer 22, a superconducting layer 23, a protective layer 24, and a stabilization layer 25.

Base material 21 is a tape made of stainless steel, for example. On base material 21, a copper layer 21a and a nickel layer 21b are cladded. Copper layer 21a is disposed on base material 21, and nickel layer 21b is disposed on copper layer 21a. Copper layer 21a and nickel layer 21b are crystal-oriented. However, base material 21 is not limited thereto. Base material 21 may be made of Hastelloy. When base material 21 is made of Hastelloy, copper layer 21a and nickel layer 21b are not cladded.

Intermediate layer 22 is disposed on base material 21. When base material 21 is a tape made of stainless steel, copper layer 21a and nickel layer 21b are interposed between intermediate layer 22 and base material 21. Intermediate layer 22 is constituted by sequentially stacking a layer of stabilized zirconia, a layer of yttrium oxide, and a layer of cerium oxide, for example.

Since nickel layer 21b is crystal-oriented as described above, intermediate layer 22 disposed thereon is also crystal-oriented. Intermediate layer 22 is formed by magnetron sputtering, for example. It should be noted that, when base material 21 is Hastelloy or the like, crystal-oriented intermediate layer 22 is formed by IBAD, for example.

Superconducting layer 23 is disposed on intermediate layer 22. Superconducting layer 23 is made of a REBCO. Superconducting layer 23 is formed by PLD, for example. Superconducting layer 23 may be formed by MOD. Since intermediate layer 22 is crystal-oriented as described above, superconducting layer 23 disposed thereon is also crystal-oriented. More specifically, a c-axis direction of crystal grains of the REBCO constituting superconducting layer 23 is along a thickness direction of superconducting layer 23.

Protective layer 24 is disposed on superconducting layer 23. Protective layer 24 is made of silver. Protective layer 24 may be made of a silver alloy. Protective layer 24 is formed by sputtering, for example.

Stabilization layer 25 is disposed on protective layer 24. Stabilization layer 25 is also disposed on a surface of base material 21 opposite to intermediate layer 22, on side surfaces of base material 21, on side surfaces of intermediate layer 22, on side surfaces of superconducting layer 23, and on side surfaces of protective layer 24. Stabilization layer 25 is made of copper. Stabilization layer 25 may be made of a copper alloy. Stabilization layer 25 is formed by plating, for example.

Second superconducting wire 20 has a second end portion 20a. Second end portion 20a is an end portion in a longitudinal direction of second superconducting wire 20. At second end portion 20a, protective layer 24 and stabilization layer 25 are removed. That is, at second end portion 20a, superconducting layer 23 is exposed.

First superconducting wire 10 and second superconducting wire 20 are disposed, for example, such that first end portion 10a and second end portion 20a are adjacent to each other.

Superconducting layer 13 at first end portion 10a is connected to superconducting layer 23 at second end portion 20a. This connection is performed using a third superconducting wire 30 and a joining layer 40, for example. Third superconducting wire 30 has a base material 31, an intermediate layer 32, and a superconducting layer 33.

Base material 31 is a tape made of stainless steel, for example. On base material 31, a copper layer 31a and a nickel layer 31b are cladded. Copper layer 31a is disposed on base material 31, and nickel layer 31b is disposed on copper layer 31a. Copper layer 31a and nickel layer 31b are crystal-oriented. However, base material 31 is not limited thereto. Base material 31 may be made of Hastelloy. When base material 31 is made of Hastelloy, copper layer 31a and nickel layer 31b are not cladded.

Intermediate layer 32 is disposed on base material 31. When base material 31 is a tape made of stainless steel, copper layer 31a and nickel layer 31b are interposed between intermediate layer 32 and base material 31. Intermediate layer 32 is constituted by sequentially stacking a layer of stabilized zirconia, a layer of yttrium oxide, and a layer of cerium oxide, for example.

Since nickel layer 31b is crystal-oriented as described above, intermediate layer 32 disposed thereon is also crystal-oriented. Intermediate layer 32 is formed by magnetron sputtering, for example. It should be noted that, when base material 31 is Hastelloy or the like, crystal-oriented intermediate layer 32 is formed by IBAD, for example.

Superconducting layer 33 is disposed on intermediate layer 32. Superconducting layer 33 is made of a REBCO. Superconducting layer 33 is formed by PLD, for example. Superconducting layer 33 may be formed by MOD. Since intermediate layer 32 is crystal-oriented as described above, superconducting layer 33 disposed thereon is also crystal-oriented. More specifically, a c-axis direction of crystal grains of the REBCO constituting superconducting layer 33 is along a thickness direction of superconducting layer 33.

Third superconducting wire 30 is disposed such that superconducting layer 33 faces superconducting layer 13 at first end portion 10a and superconducting layer 23 at second end portion 20a. Joining layer 40 is disposed between superconducting layer 33 and each of superconducting layer 13 at first end portion 10a and superconducting layer 23 at second end portion 20a.

Joining layer 40 is made of a REBCO. A c-axis direction of crystal grains of the REBCO constituting joining layer 40 is along the c-axis direction of the REBCO constituting superconducting layer 13 at first end portion 10a, the c-axis direction of the REBCO constituting superconducting layer 23 at second end portion 20a, and the c-axis direction of the REBCO constituting superconducting layer 33. Accordingly, superconducting layer 13 at first end portion 10a and superconducting layer 23 at second end portion 20a are superconducting-joined by third superconducting wire 30 (superconducting layer 33) and joining layer 40.

A portion of superconducting wire connection structure 100 where superconducting layer 13 at first end portion 10a and superconducting layer 23 at second end portion 20a are connected is referred to as a connection portion 50. Connection portion 50 has a first sandwiching member 51 and a second sandwiching member 52, and a cover member 53. It should be noted that connection portion 50 does not need to have cover member 53. Further, connection portion 50 may have joining layer 40.

First sandwiching member 51 and second sandwiching member 52 are sheet-like members. First sandwiching member 51 and second sandwiching member 52 sandwich therebetween superconducting layer 13 at first end portion 10a and superconducting layer 23 at second end portion 20a and third superconducting wire 30. First sandwiching member 51 and second sandwiching member 52 are fixed to each other by welding, for example. First sandwiching member 51 and second sandwiching member 52 may be fixed to each other by soldering.

Cover member 53 is a sheet-like member. Cover member 53 covers first sandwiching member 51 and second sandwiching member 52. More specifically, cover member 53 has a first portion 53a and a second portion 53b. Cover member 53 is folded back such that first portion 53a and second portion 53b face each other. First sandwiching member 51 and second sandwiching member 52 are disposed between first portion 53a and second portion 53b. First portion 53a is fixed to second portion 53b by soldering, for example. Thereby, the inside of cover member 53 is sealed.

A thickness in connection portion 50 is referred to as a thickness T. Thickness T is less than or equal to 2 mm. Thickness T may be less than or equal to 1.8 mm, or less than or equal to 1.5 mm. Thickness T is more than or equal to 60 μm, or more than or equal to 100 μm, for example. A thermal expansion coefficient of first sandwiching member 51, a thermal expansion coefficient of second sandwiching member 52, and a thermal expansion coefficient of cover member 53 are more than or equal to 0.95 times and less than or equal to 1.05 times a thermal expansion coefficient of base material 11, a thermal expansion coefficient of base material 21, and a thermal expansion coefficient of base material 31. Preferably, a material constituting first sandwiching member 51, a material constituting second sandwiching member 52, and a material constituting cover member 53 are identical to the material constituting base material 11, base material 21, and base material 31. In the example shown in FIG. 2, thickness T indicates a maximum thickness of a portion where first superconducting wire 10, second superconducting wire 20, third superconducting wire 30, joining layer 40, first sandwiching member 51, second sandwiching member 52, and cover member 53 are stacked.

Preferably, a thickness of first sandwiching member 51, a thickness of second sandwiching member 52, and a thickness of cover member 53 are less than or equal to 0.2 mm. The thickness of first sandwiching member 51, the thickness of second sandwiching member 52, and the thickness of cover member 53 may be less than or equal to 150 μm (0.15 mm). The thickness of first sandwiching member 51, the thickness of second sandwiching member 52, and the thickness of cover member 53 are more than or equal to 30 μm, or more than or equal to 50 μm, for example. Preferably, a thermal conductivity of first sandwiching member 51, a thermal conductivity of second sandwiching member 52, and a thermal conductivity of cover member 53 are more than or equal to 0.1×10² W/m·° C. The thermal conductivity of first sandwiching member 51, the thermal conductivity of second sandwiching member 52, and the thermal conductivity of cover member 53 may be more than or equal to 0.3×10² W/m·° C., or more than or equal to 0.5×10² W/m·° C.

A thermal resistance of connection portion 50 is more than or equal to 16° C./W, for example. The thermal resistance of connection portion 50 is measured according to the JEDEC standard (JESD51-2A). In order to measure the thermal resistance of connection portion 50, connection portion 50 is separated from superconducting wire connection structure 100. On this occasion, a length of first superconducting wire 10 and second superconducting wire 20 extending from connection portion 50 is set to less than or equal to 100 mm. Depending on the material constituting connection portion 50, the thermal resistance of connection portion 50 may be more than or equal to 18° C./W, or more than or equal to 20° C./W.

Preferably, a current density in the c-axis direction of the superconducting layers at connection portion 50 when a current of 200 A is flowing through superconducting wire connection structure 100 is less than or equal to 50 A/mm². The current density in the c-axis direction of the superconducting layers at connection portion 50 is obtained by dividing the current flowing through superconducting wire connection structure 100 by a joining area between superconducting layer 13 at first end portion 10a and joining layer 40 (or a joining area between superconducting layer 23 at second end portion 20a and joining layer 40). The current density in the c-axis direction of the superconducting layers at connection portion 50 when a current of 200 A is flowing through superconducting wire connection structure 100 may be less than or equal to 45 A/mm². The current density in the c-axis direction of the superconducting layers at connection portion 50 when a current of 200 A is flowing through superconducting wire connection structure 100 is more than or equal to 10 A/mm², for example.

(Method for Manufacturing Superconducting Wire Connection Structure in Accordance with Embodiment)

In the following, a method for manufacturing superconducting wire connection structure 100 will be described.

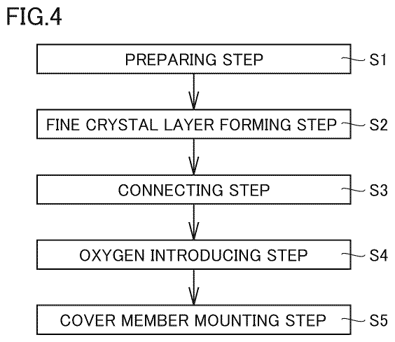

FIG. 4 is a manufacturing process diagram of superconducting wire connection structure 100. As shown in FIG. 4, the method for manufacturing superconducting wire connection structure 100 has a preparing step S1, a fine crystal layer forming step S2, a connecting step S3, an oxygen introducing step S4, and a cover member mounting step S5.

In preparing step S1, first superconducting wire 10, second superconducting wire 20, and third superconducting wire 30 are prepared.

In fine crystal layer forming step S2, a fine crystal layer is formed on superconducting layer 33. The fine crystal layer may be disposed on superconducting layer 13 at first end portion 10a and on superconducting layer 23 at second end portion 20a, instead of being disposed on superconducting layer 33. The fine crystal layer is made of a polycrystalline body of a REBCO.

For forming the fine crystal layer, firstly, an organic compound film is formed on superconducting layer 33 by spin coating, for example. This organic compound film contains constituent elements of the REBCO. Secondly, pre-calcination is performed on the organic compound film. This pre-calcination allows the organic compound film to serve as a precursor of the REBCO. Hereinafter, the pre-calcined organic compound film is referred to as a pre-calcined film. Thirdly, after the pre-calcination, heat treatment is performed on the pre-calcined film. Thereby, a carbide contained in the pre-calcined film is decomposed, and the fine crystal layer containing fine crystals of the REBCO is formed.

In connecting step S3, superconducting layer 13 at first end portion 10a and superconducting layer 23 at second end portion 20a are connected to superconducting layer 33 using the fine crystal layer. In connecting step S3, firstly, first superconducting wire 10 and the second superconducting wire are disposed such that first end portion 10a and second end portion 20a are adjacent to each other, and third superconducting wire 30 is disposed such that superconducting layer 33 faces superconducting layer 13 at first end portion 10a and superconducting layer 23 at second end portion 20a, with the fine crystal layer being interposed therebetween.

Secondly, first end portion 10a, second end portion 20a, and third superconducting wire 30 are sandwiched between first sandwiching member 51 and second sandwiching member 52. With first end portion 10a, second end portion 20a, and third superconducting wire 30 being sandwiched between first sandwiching member 51 and second sandwiching member 52, first sandwiching member 51 and second sandwiching member 52 are fixed to each other by welding or the like. Thirdly, heating and pressurization are performed on superconducting layer 13 at first end portion 10a, superconducting layer 23 at second end portion 20a, superconducting layer 33, and the fine crystal layer, via first sandwiching member 51 and second sandwiching member 52. Thereby, the fine crystals of the REBCO contained in the fine crystal layer have oriented crystallization (i.e., epitaxially grow from superconducting layer 13 at first end portion 10a, superconducting layer 23 at second end portion 20a, and superconducting layer 33) to serve as joining layer 40.

By the heating performed in connecting step S3, oxygen desorbs from superconducting layer 13 at first end portion 10a, superconducting layer 23 at second end portion 20a, superconducting layer 33, and joining layer 40. Accordingly, in oxygen introducing step S4, oxygen is introduced into superconducting layer 13 at first end portion 10a, superconducting layer 23 at second end portion 20a, superconducting layer 33, and joining layer 40, by heating and holding the connection portion under an atmosphere containing oxygen.

In cover member mounting step S5, mounting of cover member 53 is performed. Cover member 53 is mounted by folding back cover member 53 such that first sandwiching member 51 and second sandwiching member 52 are sandwiched between first portion 53a and second portion 53b, and soldering first portion 53a to second portion 53b. Thereby, superconducting wire connection structure 100 with the structure shown in FIGS. 1 to 3 is manufactured.

(Effect of Superconducting Wire Connection Structure in Accordance with Embodiment)

In the following, the effect of superconducting wire connection structure 100 will be described.

In superconducting wire connection structure 100, as the thickness of connection portion 50 (thickness T) increases, mechanical strength in connection portion 50 is improved, whereas heat dissipation in connection portion 50 is reduced. However, in superconducting wire connection structure 100, since thickness T is less than or equal to 2 mm, the heat dissipation in connection portion 50 is improved. In addition, in superconducting wire connection structure 100, since the heat dissipation in connection portion 50 is improved, a quench is less likely to occur in superconducting layer 13 at first end portion 10a, superconducting layer 23 at second end portion 20a, superconducting layer 33, and joining layer 40, even if connection portion 50 generates heat.

Breakage in connection portion 50 is caused by thermal stress due to a difference in thermal expansion coefficient between base material 11/base material 21/base material 31 and first sandwiching member 51/second sandwiching member 52/cover member 53. In superconducting wire connection structure 100, the thermal expansion coefficient of first sandwiching member 51, the thermal expansion coefficient of second sandwiching member 52, and the thermal expansion coefficient of cover member 53 are more than or equal to 0.95 times and less than or equal to 1.05 times the thermal expansion coefficient of base material 11, the thermal expansion coefficient of base material 21, and the thermal expansion coefficient of base material 31.

As a result, as base material 11, base material 21, and base material 31 thermally expand and contract, first sandwiching member 51, second sandwiching member 52, and cover member 53 also thermally expand and contract, and thus the thermal stress described above is less likely to be caused. Thus, according to superconducting wire connection structure 100, breakage in connection portion 50 can be suppressed even if thickness T is small.

In superconducting wire connection structure 100, the inside of cover member 53 is sealed to suppress moisture ingress into the inside of cover member 53. Thus, according to superconducting wire connection structure 100, superconducting properties of superconducting layer 13 at first end portion 10a, superconducting layer 23 at second end portion 20a, superconducting layer 33, and joining layer 40 are suppressed from being deteriorated by moisture.

The heat dissipation in connection portion 50 is further improved when the thickness of first sandwiching member 51, the thickness of second sandwiching member 52, and the thickness of cover member 53 are less than or equal to 0.2 mm, and the thermal conductivity of first sandwiching member 51, the thermal conductivity of second sandwiching member 52, and the thermal conductivity of cover member 53 are more than or equal to 0.1×10² W/m·° C. The heat dissipation in connection portion 50 is further improved also when the thermal resistance of connection portion 50 is more than or equal to 16° C./W.

Generally, from the viewpoint of making connection portion 50 compact, it is preferable to decrease the joining area between superconducting layer 13 at first end portion 10a and joining layer 40 (or the joining area between superconducting layer 23 at second end portion 20a and joining layer 40), that is, to increase the current density in the c-axis direction of the superconducting layers at connection portion 50. On the other hand, when the current density in the c-axis direction of the superconducting layers at connection portion 50 is decreased, the amount of heat generated in connection portion 50 is decreased.

Accordingly, if the current density in the c-axis direction of connection portion 50 when a current of 200 A is flowing through superconducting wire connection structure 100 is less than or equal to 50 A/mm², a quench is less likely to occur in superconducting layer 13 at first end portion 10a, superconducting layer 23 at second end portion 20a, superconducting layer 33, and joining layer 40, due to a decrease in the amount of heat generated in connection portion 50.

### (First Variation)

Although cover member 53 in the above example is constituted by one member, cover member 53 may be constituted by two members (hereinafter referred to as a “first member” and a “second member”). In this case, the first member and the second member constituting cover member 53 are fixed to each other by soldering or the like, in a state where they sandwich first sandwiching member 51 and second sandwiching member 52 therebetween.

### (Second Variation)

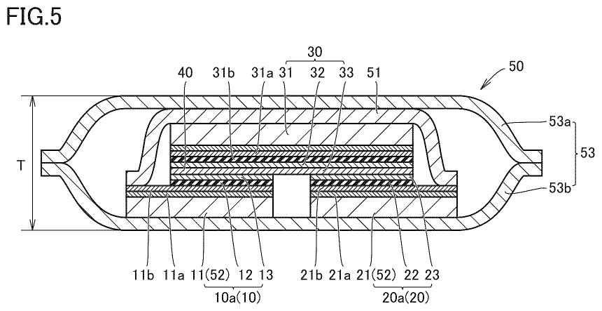

FIG. 5 is a cross sectional view of superconducting wire connection structure 100 in accordance with a second variation. FIG. 5 shows a cross section at a position corresponding to II-II in FIG. 1. As shown in FIG. 5, base material 11 at first end portion 10a and base material 21 at second end portion 20a may serve as second sandwiching member 52. In this case, intermediate layer 12 and superconducting layer 13 at first end portion 10a and intermediate layer 22 and superconducting layer 23 at second end portion 20a are partially removed, and then first sandwiching member 51 is fixed to base material 11 and base material 21 by welding or the like. It should be noted that, in the example shown in FIG. 5, thickness T indicates a maximum thickness of a portion where first superconducting wire 10, second superconducting wire 20, third superconducting wire 30, joining layer 40, first sandwiching member 51, and cover member 53 are stacked. Also in this case, since thickness T is less than or equal to 2 mm, the heat dissipation in connection portion 50 is improved. Further, since the thermal expansion coefficient of first sandwiching member 51, the thermal expansion coefficient of second sandwiching member 52 (base material 21), and the thermal expansion coefficient of cover member 53 are more than or equal to 0.95 times and less than or equal to 1.05 times the thermal expansion coefficient of base material 11, the thermal expansion coefficient of base material 21, and the thermal expansion coefficient of base material 31, breakage in connection portion 50 caused by thermal stress can be suppressed.

Although not shown, base material 31 may serve as first sandwiching member 51. In this case, intermediate layer 32 and superconducting layer 33 are partially removed, and then second sandwiching member 52 is fixed to base material 31 by welding or the like.

### (Third Variation)

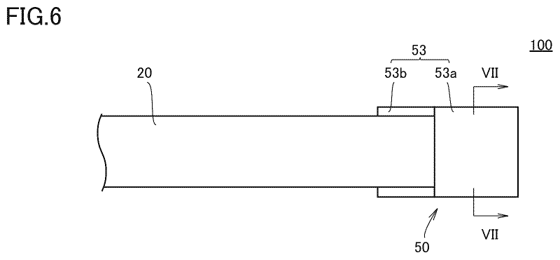

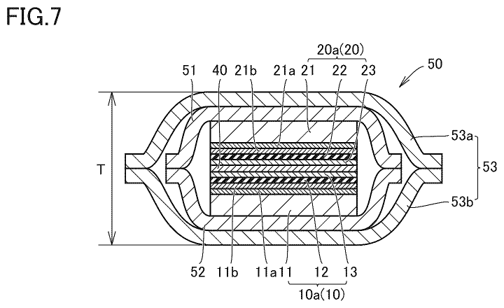

FIG. 6 is a plan view of superconducting wire connection structure 100 in accordance with a third variation. FIG. 7 is a cross sectional view taken along VII-VII in FIG. 6. As shown in FIGS. 6 and 7, first superconducting wire 10 and second superconducting wire 20 may be disposed to be stacked such that superconducting layer 13 at first end portion 10a and superconducting layer 23 at second end portion 20a face each other with joining layer 40 being interposed therebetween. In this case, third superconducting wire 30 is not used in superconducting wire connection structure 100. In this way, the manner of connecting first superconducting wire 10 and second superconducting wire 20 is not limited to the examples shown in FIGS. 1 to 3. It should be noted that, in the example shown in FIG. 7, thickness T indicates a maximum thickness of a portion where first superconducting wire 10, second superconducting wire 20, joining layer 40, first sandwiching member 51, second sandwiching member 52, and cover member 53 are stacked. Also in this case, since thickness T is less than or equal to 2 mm, the heat dissipation in connection portion 50 is improved. Further, since the thermal expansion coefficient of first sandwiching member 51, the thermal expansion coefficient of second sandwiching member 52, and the thermal expansion coefficient of cover member 53 are more than or equal to 0.95 times and less than or equal to 1.05 times the thermal expansion coefficient of base material 11 and the thermal expansion coefficient of base material 21, breakage in connection portion 50 caused by thermal stress can be suppressed.

### (Fourth Variation)

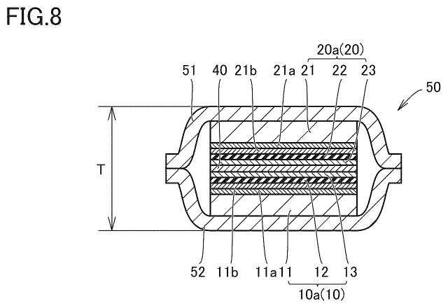

FIG. 8 is a cross sectional view of superconducting wire connection structure 100 in accordance with a fourth variation. FIG. 8 shows a cross section at a position corresponding to VII-VII in FIG. 6. As shown in FIG. 8, in superconducting wire connection structure 100, first superconducting wire 10 and second superconducting wire 20 may be disposed to be stacked such that superconducting layer 13 at first end portion 10a and superconducting layer 23 at second end portion 20a face each other with joining layer 40 being interposed therebetween, and third superconducting wire 30 and cover member 53 do not need to be used. It should be noted that, in the example shown in FIG. 8, thickness T indicates a maximum thickness of a portion where first superconducting wire 10, second superconducting wire 20, joining layer 40, first sandwiching member 51, and second sandwiching member 52 are stacked. Also in this case, since thickness T is less than or equal to 2 mm, the heat dissipation in connection portion 50 is improved. Further, since the thermal expansion coefficient of first sandwiching member 51 and the thermal expansion coefficient of second sandwiching member 52 are more than or equal to 0.95 times and less than or equal to 1.05 times the thermal expansion coefficient of base material 11 and the thermal expansion coefficient of base material 21, breakage in connection portion 50 caused by thermal stress can be suppressed.

### (Fifth Variation)

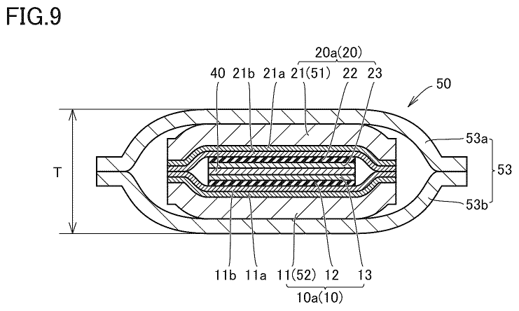

FIG. 9 is a cross sectional view of superconducting wire connection structure 100 in accordance with a fifth variation. FIG. 9 shows a cross section at a position corresponding to VII-VII in FIG. 6. As shown in FIG. 9, superconducting wire connection structure 100 does not need to have third superconducting wire 30, and first superconducting wire 10 and second superconducting wire 20 may be disposed to be stacked such that superconducting layer 13 at first end portion 10a and superconducting layer 23 at second end portion 20a face each other with joining layer 40 being interposed therebetween.

Further, in superconducting wire connection structure 100, base material 11 may serve as second sandwiching member 52, and base material 21 may serve as first sandwiching member 51. In this case, intermediate layer 12 and superconducting layer 13 at first end portion 10a and intermediate layer 22 and superconducting layer 23 at second end portion 20a are partially removed, and then base material 11 and base material 21 are fixed to each other by welding or the like. It should be noted that, in the example shown in FIG. 9, thickness T indicates a maximum thickness of a portion where first superconducting wire 10, second superconducting wire 20, joining layer 40, first sandwiching member 51, second sandwiching member 52, and cover member 53 are stacked. Also in this case, since thickness T is less than or equal to 2 mm, the heat dissipation in connection portion 50 is improved. Further, since the thermal expansion coefficient of first sandwiching member 51 (base material 11), the thermal expansion coefficient of second sandwiching member 52 (base material 21), and the thermal expansion coefficient of cover member 53 are more than or equal to 0.95 times and less than or equal to 1.05 times the thermal expansion coefficient of base material 11 and the thermal expansion coefficient of base material 21, breakage in connection portion 50 caused by thermal stress can be suppressed.

### (Sixth Variation)

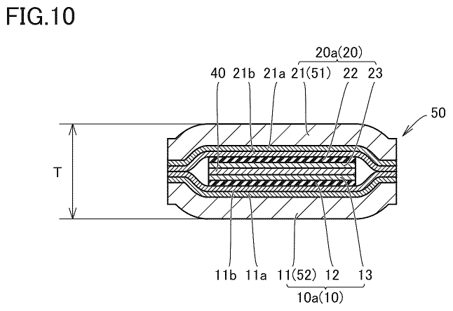

FIG. 10 is a cross sectional view of superconducting wire connection structure 100 in accordance with a sixth variation. FIG. 10 shows a cross section at a position corresponding to VII-VII in FIG. 6. As shown in FIG. 10, in superconducting wire connection structure 100, first superconducting wire 10 and second superconducting wire 20 may be disposed to be stacked such that superconducting layer 13 at first end portion 10a and superconducting layer 23 at second end portion 20a face each other with joining layer 40 being interposed therebetween. Further, in superconducting wire connection structure 100, base material 11 may serve as second sandwiching member 52 and base material 21 may serve as first sandwiching member 51, and base material 11 and base material 21 may be fixed to each other. Furthermore, superconducting wire connection structure 100 does not need to have third superconducting wire 30 and cover member 53. It should be noted that, in the example shown in FIG. 10, thickness T indicates a maximum thickness of a portion where first superconducting wire 10, second superconducting wire 20, and joining layer 40 are stacked. Also in this case, since thickness T is less than or equal to 2 mm, the heat dissipation in connection portion 50 is improved. Further, since the thermal expansion coefficient of first sandwiching member 51 (base material 11) and the thermal expansion coefficient of second sandwiching member 52 (base material 21) are more than or equal to 0.95 times and less than or equal to 1.05 times the thermal expansion coefficient of base material 11 and the thermal expansion coefficient of base material 21, breakage in connection portion 50 caused by thermal stress can be suppressed.

It should be understood that the embodiment disclosed herein is illustrative and non-restrictive in every respect. The scope of the present invention is defined by the scope of the claims, rather than the embodiment described above, and is intended to include any modifications within the scope and meaning equivalent to the scope of the claims.

### REFERENCE SIGNS LIST

10: first superconducting wire; 10a: first end portion; 11: base material; 11a: copper layer; 11b: nickel layer; 12: intermediate layer; 13: superconducting layer; 14: protective layer; 15: stabilization layer; 20: second superconducting wire; 20a: second end portion; 21: base material; 21a: copper layer; 21b: nickel layer; 22: intermediate layer; 23: superconducting layer; 24: protective layer; 25: stabilization layer; 30: third superconducting wire; 31: base material; 31a: copper layer; 31b: nickel layer; 32: intermediate layer; 33: superconducting layer; 40: joining layer; 50: connection portion; 51: first sandwiching member; 52: second sandwiching member; 53: cover member; 53a: first portion; 53b: second portion; 100: superconducting wire connection structure; S1: preparing step; S2: fine crystal layer forming step; S3: connecting step; S4: oxygen introducing step; S5: cover member mounting step; T: thickness.

1. A superconducting wire connection structure comprising:
a first superconducting wire; and
a second superconducting wire, wherein
the first superconducting wire has a first end portion in a longitudinal direction of the first superconducting wire,
the second superconducting wire has a second end portion in a longitudinal direction of the second superconducting wire,
each of the first superconducting wire and the second superconducting wire has a base material, an intermediate layer disposed on the base material, and a superconducting layer disposed on the intermediate layer,
a connection portion, which is a portion of the superconducting wire connection structure where the superconducting layer at the first end portion and the superconducting layer at the second end portion are connected, has a first sandwiching member and a second sandwiching member,
the superconducting layer at the first end portion and the superconducting layer at the second end portion are sandwiched between the first sandwiching member and the second sandwiching member,
a thickness of the connection portion is less than or equal to 2 mm, and
a thermal expansion coefficient of the first sandwiching member and a thermal expansion coefficient of the second sandwiching member are more than or equal to 0.95 times and less than or equal to 1.05 times a thermal expansion coefficient of the base material.

2. The superconducting wire connection structure according to claim 1, wherein
the connection portion further has a cover member,
the first sandwiching member and the second sandwiching member are covered with the cover member, and
a thermal expansion coefficient of the cover member is more than or equal to 0.95 times and less than or equal to 1.05 times the thermal expansion coefficient of the base material.

3. The superconducting wire connection structure according to claim 2, further comprising a third superconducting wire, wherein
the third superconducting wire has the base material, the intermediate layer, and the superconducting layer,
the superconducting layer of the third superconducting wire is disposed to face the superconducting layer at the first end portion and the superconducting layer at the second end portion, and
the first sandwiching member and the second sandwiching member sandwich therebetween the first end portion, the second end portion, and the third superconducting wire.

4. The superconducting wire connection structure according to claim 2, wherein
a thermal conductivity of the first sandwiching member, a thermal conductivity of the second sandwiching member, and a thermal conductivity of the cover member are more than or equal to 0.1×10² W/m·° C., and
a thickness of the first sandwiching member and a thickness of the second sandwiching member are less than or equal to 0.2 mm.

5. The superconducting wire connection structure according to claim 2, wherein a thermal resistance of the connection portion is more than or equal to 16° C./W.

6. The superconducting wire connection structure according to claim 1, wherein
a c-axis direction of crystal grains of an oxide superconductor constituting the superconducting layer is along a thickness direction of the superconducting layer, and
a current density in the c-axis direction of the superconducting layers at the connection portion when a current of 200 A is flowing through the superconducting wire connection structure is less than or equal to 50 A/mm².
